(19) United States
(12) Patent Application Publication
(10) Pub. No.: US 2015/0025969 A1
(43) Pub. Date: Jan. 22, 2015

(54) Multisystem Interface for Roaming Self-Checkout

(71) Applicant: Fetch Rewards, LLC, Madison, WI (US)

(72) Inventors: Wes Schroll, Madison, WI (US); Keith Jackson, JR., Madison, WI (US)

(21) Appl. No.: 14/300,393

(22) Filed: Jun. 10, 2014

Related U.S. Application Data
(60) Provisional application No. 61/847,796, filed on Jul. 18, 2013.

(51) Int. Cl. G06Q 20/18; G06Q 20/32; G06Q 30/06

(52) U.S. Cl. CPC G06Q 20/18; G06Q 30/0633; G06Q 20/327
USPC 705/14.53; 705/21; 705/14.64

(57) ABSTRACT

An interface device fits between a point-of-sale terminal and a peripheral element, for example, the UPC scanner, to permit a rapid checkout of groceries or the like by simulating rapid scanning of a stored grocery list accumulated by a consumer in a roaming checkout through the store. The consumer scans items as he or she shops to create the stored grocery list. A promotional system for providing coupons at the point of purchase decision and the novel method of handling items that need to be weighed are also provided.

### CROSS REFERENCE TO RELATED APPLICATION

This application claims the benefit of U.S. provisional application Ser. No. 61/847796 filed Jul. 18, 2013 and hereby incorporated by reference.

### BACKGROUND OF THE INVENTION

The present invention relates to systems for “self-checkout” that enable customers to scan purchasing data themselves and in particular to a roaming self-checkout system allowing customers to enter purchasing data as they move throughout the store and remove product from the shelves.

Self-checkout point-of-sale (POS) systems, for example, in checkout lanes of a grocery store, allow consumer to scan, bag and pay for their purchases without the intervention of an employee. Such systems offer cost savings in reduced labor and increased convenience for the consumer by increasing checkout capacity.

One limitation to self-checkout systems is the need for the consumer to scan and weigh individual items after they arrive at the checkout lane, such as may create a bottleneck in the checkout process. Accordingly, it is known to provide the consumer with “roaming” scanners that allow the consumer to scan items as they are taken off the shelf and placed in the cart. Such scanners may actually or virtually (by wireless communication with the central processing system) store a complete list of scanned items that may then be uploaded at the point of checkout substantially instantaneously.

The inconvenience and cost of providing customers with mobile scanners as well as an interest in capturing customer purchasing information across multiple stores, typically using different POS systems, has led to the development of smart phone scanners where the consumer may use his or her own smart phone as a scanner. Ideally the consumer would perform self-checkout scanning using a smart phone at multiple stores providing a more comprehensive view of consumer behavior.

An obstacle to such a universal self-checkout system is the proprietary nature of most POS systems. Different proprietary PUS systems may be employed even within a single store chain. The difficulty of interfacing to these different proprietary systems, or implementing a common standard among different manufacturers who have some economic interests in preventing interoperability, make implementing a universal self-checkout system employing smart phones difficult.

### SUMMARY OF THE INVENTION

The present invention provides a substantially universal interface for roaming self-checkout systems using a smart phone or the like that may work with multiple proprietary POS systems. In this respect, the inventors have recognized that despite proprietary software among different POS systems, the hardware elements of the laser UPC scanner, the scale, and to a lesser extent a computer keyboard, provide de facto common interfaces to these systems. Accordingly, the present invention provides an interface that can be inserted between these hardware elements and the PUS system and that may mimic the hardware element, for example, outputting data that appears to be a UPC scanner. Uploading information to the POS system is thus performed by simulating a rapid manual scanning of actual product. The efficiency of this mimicking process is such as to substantially reduce the checkout time to a speed comparable with other uploading mechanisms.

Specifically, in one embodiment, the present invention provides a checkout system having an interface adapter attachable to a point-of-sale system between a point-of-sale computer and a peripheral device, the peripheral device inputting information about a purchase of products by a consumer for recording by the point-of-sale computer. An interface electronic computer system communicates with the interface adapter and a receiver communicating with a mobile wireless device to: (a) receive a list of products for purchase by a consumer from a mobile wireless device operated by the consumer: (b) convert the product list into a data form used by the peripheral device to communicate with the point-of-sale computer to provide a simulated peripheral datastream; and (c) transmit the simulated peripheral datastream to the interface adapter to be communicated to the point-of-sale system in the manner of data normally received by the peripheral device to simulate inputting of information about the purchase of products by the consumer through the peripheral device.

It is thus a feature of at least one embodiment of the invention to permit a roaming checkout system to be easily implemented with different proprietary point-of-sale systems.

The peripheral device may be a barcode scanner and the data form may be that of scanned UPC codes.

It is thus a feature of at least one embodiment of the invention to simulate a highly standardized peripheral to reduce the need for multiple encoding systems for different peripheral types.

The interface adapter may include a switch controllable by the interface electronic computer system wherein the interface electronic computer system may actuate the switch during step (c) to provide a connection between the interface electronic computer system and the point-of-sale electronic system, and upon completion of step (c) may actuate the switch to break the connection between the interface electronic computer system and the point-of-sale system and make a connection between the peripheral and the point-of-sale system.

It is thus a feature of at least one embodiment of the invention to integrate a roaming checkout system into a standard point-of-sale system while preserving normal point-of-sale operation requiring manual scanning of products.

The receiver may be a cell phone system receiver receiving cell phone encoded data from the mobile device.

It is thus a feature of at least one embodiment of the invention to permit integration of a roaming checkout system into a store without extensive modifications to or integration with local wireless systems.

The checkout system may include a mobile wireless device providing a camera, a user-display, and a user data entry device and incorporating a user electronic computer communicating with the camera and display. This mobile wireless device may execute an application program to (i) scan product tags identifying a product to provide a product identifier and (ii) display information about a product related to the product identifiers on the user-display for editing by the user through commands entered through the user-data entry device. The edited product identifiers may be (iii) stored in a virtual shopping cart and data of the virtual shopping cart may be (iv) transmitted to interface electronic computer system to provide the list of products for purchase by a consumer.

It is thus a feature of at least one embodiment of the invention to permit roaming-type checkout using a standard wireless device such as a cell phone.

The mobile wireless device may further transmit product identifiers contemporaneously with step (i) to the interface electronic computer system and the interface electronic computer may further include a database of promotions identified to particular products so that it can transmit a promotion to the mobile wireless device based on the received product identifiers.

It is thus a feature of at least one embodiment of the invention to permit promotional placement contemporaneous with purchase decisions rather than at a time of checkout.

The interface electronic computer system may receive data over a network connection from a consumer indicating consumer preferences wherein at step (a) the interface electronic computer system may make an identification of the consumer allowing matching of the consumer preferences to the list of products so that the promotion at step (d) may be based on the consumer preferences. These consumer preferences may indicate an intended social event involving the purchase of products, as an example.

It is thus a feature of at least one embodiment of the invention to permit the consumer to provide additional information identifying useful or desirable product promotions tailored to the consumer.

Step (ii) on the wireless mobile device may include an editing by the user that deletes a product identifier after scanning of step (i) and the wireless device may further (v) transmit to the interface electronic computer system a list of products scanned but not purchased by the consumer based on a recorded deleting of a product identifier after scanning and after receiving a promotion on a similar product.

It is thus a feature of at least one embodiment of the invention to provide feedback about the effectiveness of a promotion in influencing a purchasing decision.

The interface adapter may include a first and second releasable electrical connector where the first electrical connector is adapted to be received by the corresponding electrical connector on the point-of-sale system and the second electrical connector is adapted to receive a corresponding connector on the peripheral.

It is thus a feature of at least one embodiment of the invention to provide a simple method of integrating the system of the present invention into existing point-of-sale computer systems without irreversible modification of point-of-sale computer system.

In another embodiment, the invention provides an electronic scale system having a platform providing an upwardly facing surface for receiving items to be weighed and a weight sensor communicating with the platform to provide an electronic signal indicating a weight of an item on the platform and an electronic display viewable by a user of the platform. A scale electronic computer may communicate with the weight sensor and the display to receive the electronic signal indicating a weight of an item on the platform and display on the display machine-readable element encoding a weight value together with a human readable element encoding the weight value.

It is thus a feature of at least one embodiment of the invention to provide a method of integrating scales into a roaming checkout system employing a user's cell phone or the like without the need for complex radio data communication between the scales and remote computers or the phone.

The machine-readable element may further encode a scale identifier number uniquely identifying the electronic scale.

It is thus a feature of at least one embodiment of the invention to prevent spoofing of scale data with a printed machine-readable element or the like.

In yet another embodiment, the invention may provide a checkout system employing a product-merchandising stand holding product and a machine-readable scan code located on the stand separate from product held by the stand. An interface electronic computer system communicates with a wireless transceiver and holds a data structure linking product identifiers to machine-readable scan codes. In this embodiment the mobile wireless device may scan the machine-readable scan code and display information about one or more products proximate to the machine-readable scan code for selection by the user through commands entered through the user-data entry device. The selected display products are stored in a virtual shopping cart and the data of the virtual shopping cart is transmitted to the interface electronic computer system to provide the list of products for purchase by a consumer.

It is thus a feature of at least one embodiment of the invention to provide a simple method of incorporating loose products such as produce that may have no UPC or unreliable UPC marking into a roaming checkout system.

These particular objects and advantages may apply to only some embodiments falling within the claims and thus do not define the scope of the invention.

### BRIEF DESCRIPTION OF THE FIGURES

FIG. 1 is a simplified perspective view of the self-checkout system employing the present invention and showing the interface of the present invention at a self-checkout kiosk and a remote produce weighing station;

FIG. 2 is a simplified block diagram of a proprietary point-of-sale system showing various connections to standard hardware components used in the POS system and showing the interface of the present invention as installed between the POS system and those hardware components;

FIG. 3 is a schematic representation of an interface of the present invention as may receive a data structure from a user's mobile device to mimic a manual checkout process;

FIG. 4 is a flowchart of the principal steps employed by the interface unit of the present invention in simulating a manual checkout process;

FIG. 5 is a perspective view of a roaming scanning of a grocery item showing the structure of the smart phone and the display presented to the consumer;

FIG. 6 is a representation of a store floor plan showing use of the scanned UPC codes to extract a consumer trajectory through the store aisles;

FIG. 7 is a flowchart of a program executed by a remote server cooperating with the smart phone to provide information about products;

FIG. 8 is a data flow diagram showing an automatic couponing system for parties that may be implemented by the present invention;

FIG. 9 is a fragmentary perspective view of a produce table having a re-assignable UPC code associated with one or more products on the table and showing a handheld tablet used by an employee for implementing that assignment and a mobile device for scanning the barcode by a consumer when the product is to be purchased;

FIG. 10 is a perspective fragmentary view of a produce scale and a block diagram of the elements of that scale as may be used with the present invention to provide a machine-readable indication of measured weight;

FIG. 11 is a flowchart that may be implemented on the tablet of FIG. 1 by an employee at a point of checkout for spot-checking purchased items;

FIG. 12 is a data table structure that may be stored in a computer system of FIG. 1 for managing a shopping list, creating a dynamic shopping list and providing the consumer with additional shopping information about the consumer's purchases among different retailers;

FIG. 13 is a depiction of the screen on a user's cell phone showing a display of the shopping lists generated using the data of FIG. 12; and

FIG. 14 is a flowchart of a program executable on the interface electronic computer system of FIG. 1 to provide a web-based portal providing the consumer with additional purchasing insight based on their use of the present invention.

### DETAILED DESCRIPTION OF THE PREFERRED EMBODIMENT

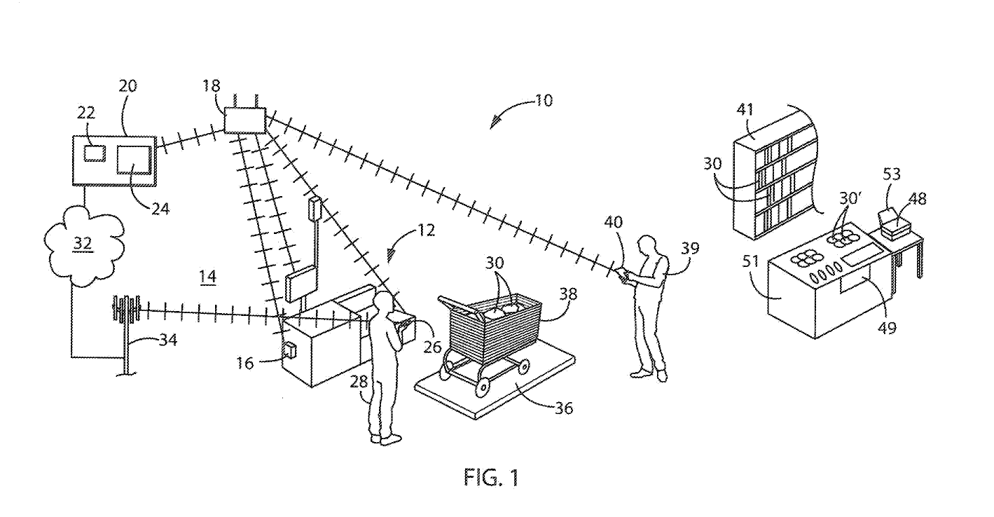

Referring now to FIG. 1, the present invention may work within a grocery store or other retail environment 10 providing, for example, a checkout kiosk 12 positioned near the exit of a store for completion of purchase transactions. The checkout kiosk 12 may include a POS system 14 such as systems commercially available from NCR and IBM as will be discussed below. As is generally understood in the art, a POS system generally provides for the checkout of customers who purchase multiple items such as groceries providing a total purchase amount, tracking acceptance of payment by the customer, providing a receipt, and recording the transaction which may be used with additional features such as inventory management and the like.

### Hardware and Environment

An interface device 16 of the present invention may be positioned near the POS system 14 to connect thereto as will be described and to receive a source of electrical power, for example, from a power line powering the POS system 14. The interface device 16 may communicate, for example, by wire or a local wireless network 18 to a remote interface server 20 including a processor 22 and memory 24 holding a stored program as will be described below.

The interface server 20 also provides for a link to a mobile wireless device 26 such as a smart phone or tablet held by a consumer 28 shopping in the retail environment 10 and, as depicted, checking out products 30 such as groceries. This link may be via the Internet 32, for example, through the gateway of a cell phone tower 34 to communicate with the mobile wireless device 26 by cell phone protocol or via the wireless network 18 according to techniques well known in the art. The interface device 16 may also communicate with the mobile wireless device 26, for example, by a local communication link such as Bluetooth or other wireless paths described above.

An optional weigh mat 36 ma be provided at the checkout kiosk 12 allowing a weighing of a cart 38 holding the products 30 to be checked out. The weigh mat 36 may also communicate with the interface device 16 to provide a confirmation of the accuracy of the self-checkout.

A store employee 39 in the vicinity of the checkout kiosk 12 may be provided, for example, with a wireless computing device such as a tablet 40 that may also communicate with the interface device 16 via the wireless network 18.

The retail environment 10 may include shelves 41 holding product 30 marked with UPC codes as is understood in the art. Elsewhere, products 30′ such as produce may be available at tables 51 near a scale 48. As will be discussed below the tables 51 may be marked with area-relevant UPC codes 49. The scale 48 may include a display 53 as will be discussed below or optionally may provide a Bluetooth or other electrical interface to the customer's mobile wireless device 26 or the remote interface server 20 for the recording of weight of purchased produce as will be discussed below.

Generally, the interface device 16 of the present invention will be used in the last step of a process in which the consumer 28 moves through the retail environment 10 after placing products 30 or 30′ in the cart 38 while scanning the UPC codes of those products (or the area-relevant UPC code 49) and, as appropriate, collecting weights for those products from the remote scales 48.

Upon checkout, the data collected by the consumer 28 is communicated at high speed to the interface device 16 into the POS system 14 to complete the transaction without the need for additional scanning. The gross weight of the products 30 may be compared to the weight obtained from the weigh mat 36 and any discrepancy together with a list of all the purchase products provided to the employee 39 for confirmation.

Other options for the employee 39 include the ability to add missing items. For example, if, upon checkout, the consumer 28 had not scanned an item that, whether because the customer simply forgot to scan it or was trying to hide it in their cart, the employee 39 has the ability to scan that item from their tablet and add it to the customer's shopping list and total. An efficient method for random sampling is described further below.

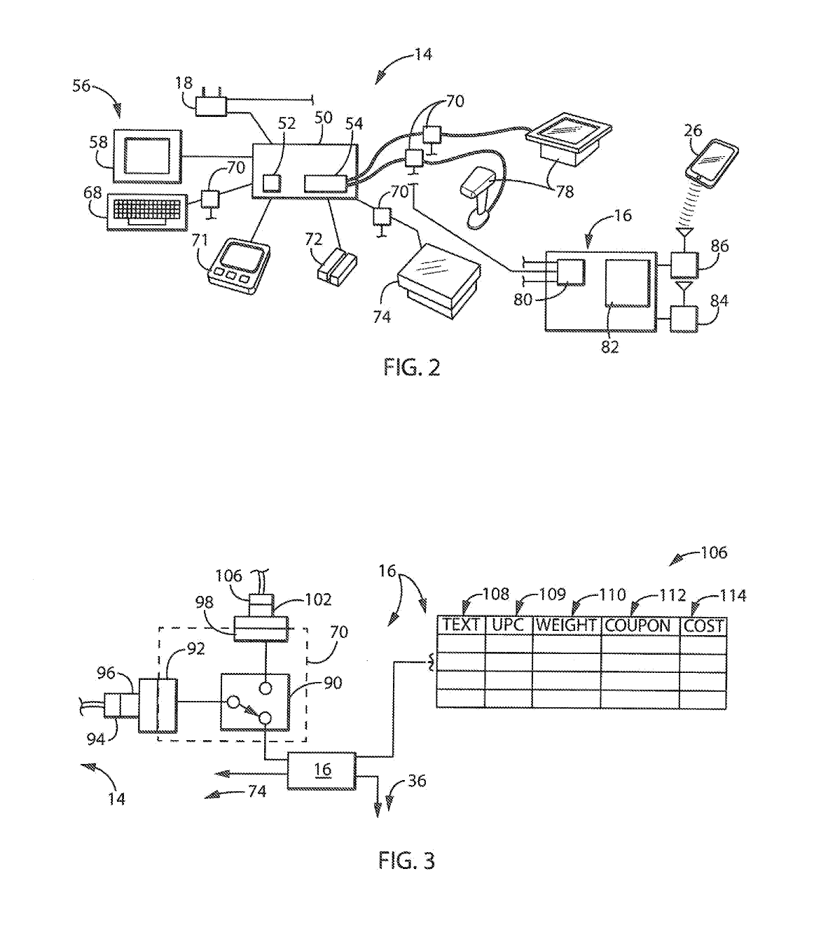

Referring now to FIG. 2, as noted above, the POS system 14 (which need not be a self-checkout system but may be a standard point-of-sale system having a human attendant) will typically be a proprietary device handling not only the sale of goods but the collection of statistics, management of inventory, generation of ordering information and/or management reports for operators of the retail environment 10. At its core, the point-of-sale system includes electronic POS computer 50 having a processor 52 and a memory 54 holding a stored proprietary program. The POS computer 50 may interface with a variety of standard products including, for example, the wireless network 18, and attendant terminal 56 including, for example, a display screen 58 and keyboard 68, and a customer payment terminal 71, for example, mirroring information from the display screen 58 to the customer with respect to the total cost of goods and allowing entry of pin numbers, the “swiping” of credit cards and entry of other payment information including a customer signature. POS computer 50 may also communicate with a magnetic card reader 72 and electronic scale 74 for weighing produce and the like and importantly with a laser or other type of UPC scanner 78 being either a hand scanner or flatbed scanner of types well known in the art.

Each of the scanners 78 optically reads a UPC code and provides the UPC code data in one of a limited number of standard serial formats to the proprietary POS computer 50. This electrical interconnection of the various peripheral devices to the POS computer 50 (typically through releasable electrical connectors) provides the possibility of a nonproprietary input to the POS system that may be used by the interface device 16 of the present invention through the mechanism of an interface connector system 70 as will be described below. Alternatively, a similar interface connector system 70 may be placed between the scale 74 and the POS computer 50 and optionally the keyboard 68 of the attendant in various embodiments of the invention according to the principles that will now be described.

The interface device 16 generally provides an interface computer 80 and an associated memory 82 and executes a stored program in the memory 82 whose operation will be described below. It will be appreciated that interface computer 80 may be wholly within the kiosk 12 or may be in part or completely remote and communicating with the interface device 16 by a network or the like. Interface device 16 further provides a Wi-Fi interface 84 for communicating with the remote interface server 20 (shown in FIG. 1) as described and may provide a Bluetooth link 86 or other near field communication device for communication with a customer's mobile wireless device 26. It will be appreciated that similar communication linkage may be provided by the Wi-Fi interface 84 instead.

Referring now to FIG. 3, the interface connector system 70 provides for an internal dual-throw, multi-pole electrical switch 90 (for example, a relay or solid state switch) having a first set of contacts of a common terminal connected to a first multi-pin electrical connector 92 that may connect with a corresponding connector 94 of the POS computer 50 in lieu of the connector otherwise directly received from a scanner 78. This connection may be via a directly compatible electrical connector or may make use of an adapter 96 of types known in the art.

The contacts of the terminal of one throw of the electrical switch 90 may then connect to a releasable electrical connector 98 of the same class but opposite gender of connector 92 to receive a connector 100 from the actual scanner 78 either directly or by means of a connector adapter 102 of a type well known in the art. The contacts of the terminal of the second throw of the electrical switch 90 may connect to the interface device 16 which may also control the state of the electrical switch 90. In this way, the POS system 14 may either receive data directly from the scanner 78 or simulated data from the interface device 16.

An analogous interface connector system 70 (not shown) may be provided for the scale 74 so that the POS system 14, by switching electrical switch 90, may receive simulated scale values instead of actual values from the scale 74.

In an alternate embodiment (not shown), the functionality of the interface connector system 70 may be realized by multiple standard ports on the POS computer 50 implementing the POS system 14. For example, interface device 16 may communicate directly with one USB port on PUS computer 50 and one or both of the scanners 78 may communicate with different USB ports. The ports may be both accommodated by the program of the PUS computer 50 by configuration or inherently in the operation of the program so that data may be accepted from either port essentially providing the switching action of the interface connector system 70. The ports need not be USB ports but may be any ports provided by the computer platform and compatible with the program of the POS computer 50 including, for example, RS-232, FireWire, or the like. In this case interface device 16 need not perform a discrete switching action but simply introduces its data at one of the connected ports with the expectation that the other scanners 78 will remain idle during this time or that the data will be interleaved effecting a high speed switching. In both cases the interface connector system 70 may be considered to be an interface adapter fitting between the PUS computer 50 and the interface device 16.

Generally the scanners provide data mimicking a computer keyboard, so the interface device 16 may also employ that protocol in providing data.

When a consumer 28 is ready for the final stage of roaming self-checkout, the interface device 16 switches the electrical switch 90 to receive data from the interface device 16 and begins a high-speed simulation of a manual checkout. This high-speed simulated manual checkout makes use of a shopping cart data list 106 held in the interface device 16 or accessible therefrom.

The shopping cart data list 106 provides a list of all of the items to be checked out previously populated during the roaming self-checkout by the consumer 28. Generally, the shopping cart data list 106 may provide a logical table providing a text description 108 of each product, a UPC code 109 for each product, a gross weight 110 of each product (used for verification purposes and possibly from a list of standard weights for standard products) and/or a net weight of products sold by weight (as obtained from a remote scale 48), a coupon link 112 for any coupons applicable to the product or other promotions, and product cost 114. During this roaming checkout process, the shopping cart data list 106 collects UPC codes and then uses them as an index value to a database within the interface server 20 that provides the latest product costs and other information (for example, net weight, unit pricing, nutritional information) which may be displayed to the user.

### Software and Operation

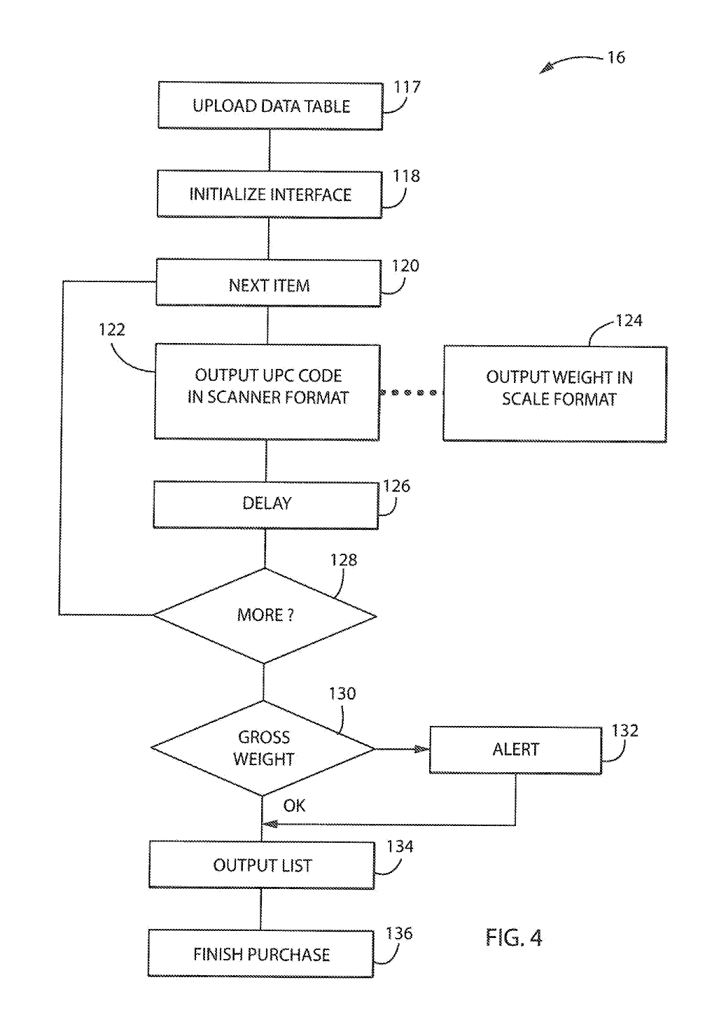

Referring now to FIG. 4, a program executing on the interface device 16 may upload the shopping cart data list 106 from the mobile wireless device 26 or the interface server 20 (depending on the desired implementation) when the consumer 28 arrives at the checkout kiosks 12, as indicated by process block 117. When the shopping cart data list 106 is uploaded from the mobile wireless device 26, it may be transmitted by a local connection such as Bluetooth or near field communication, or by communication over the wireless network 18 or via a phone data channel through cell phone tower 34. The initiation of this uploading process may occur by the customer providing input to the mobile wireless device 26 or by automatic detection of the cell phone by the interface device 16.

Once this data of the shopping cart data list 106 is uploaded, the interface device 16 initializes the interface connector systems 70 as indicated by process block 118 to switch the POS system 14 from communicating with the scanner 78 or scale 74 or keyboard 68 (or any individual or combination of these elements) to receiving information directly from the interface device 16 which will simulate those disconnected devices.

The checkout process begins at process block 120 where it reads the next item in the shopping cart data list 106 (initially being the first row in the shopping cart data list 106). At process block 122, the interface device 16 outputs through the interface connector system 70 a simulated scan of a UPC code being identical to a format of data provided, by a scanner 78 as if the real UPC code were being scanned. Generally there are several different scanner formats which may be preprogrammed into the interface device 16 during installation depending on the brand or configuration of the scanner 78.

As indicated by process block 124, this UPC input may be followed or accompanied by a net weight value for those items such as produce that require a weight, communicated, for example, through an interface connector system 70 on the scale 74. Alternatively, but not shown, this information can he input through the keyboard 68 making use of manual override capabilities available in most POS systems. Alternatively, as will be discussed below, and area-relevant UPC code may be provided that employs a random weight UPC code (also known as UPC guideline 11 code) hereby incorporated by reference. This random weight UPC code incorporates the final retail price of the package in the barcode itself allowing the proper price per pound to be charged at retail.

At process block 126, a delay may be introduced to accommodate any delays enforced by the POS system, for example, to prevent accidental duplicate scanning, and at decision block 128, if there are still items in the shopping cart data list 106, this process is repeated. Despite this delay, the process of scanning, multiple items is far faster than can be obtained by human scanner.

Once the checkout process is complete, as indicated by arriving at the final entry to the shopping cart data list 106 at decision block 130, a gross weight of all of the checked out items is totaled and compared to a weight registered by the weigh mat 36 (or by other techniques) to see if they match within a predetermined error amount. If the mismatch exceeds a predetermined threshold accommodating variations in the weight of carts 38 and accuracy of the weigh mat 36, an alert is transmitted to employee 39 at process block 132 and in all cases the employee 39 receives a list of all of the checked out groceries on a tablet or the like. The employee 39 may use the list of checked out groceries for visual comparison, as indicated by process block 134, and at process block 136. Upon approval of the checkout by the employee 39, the transaction is completed, payment having been tendered using standard features of the self-checkout kiosk 12 such as the card reader 72 and customer payment terminal 71 or manual keyboard for payment by credit card or the like. An alternative technique for sampling checked out groceries by the employee 39 is discussed below.

### Roaming Checkout

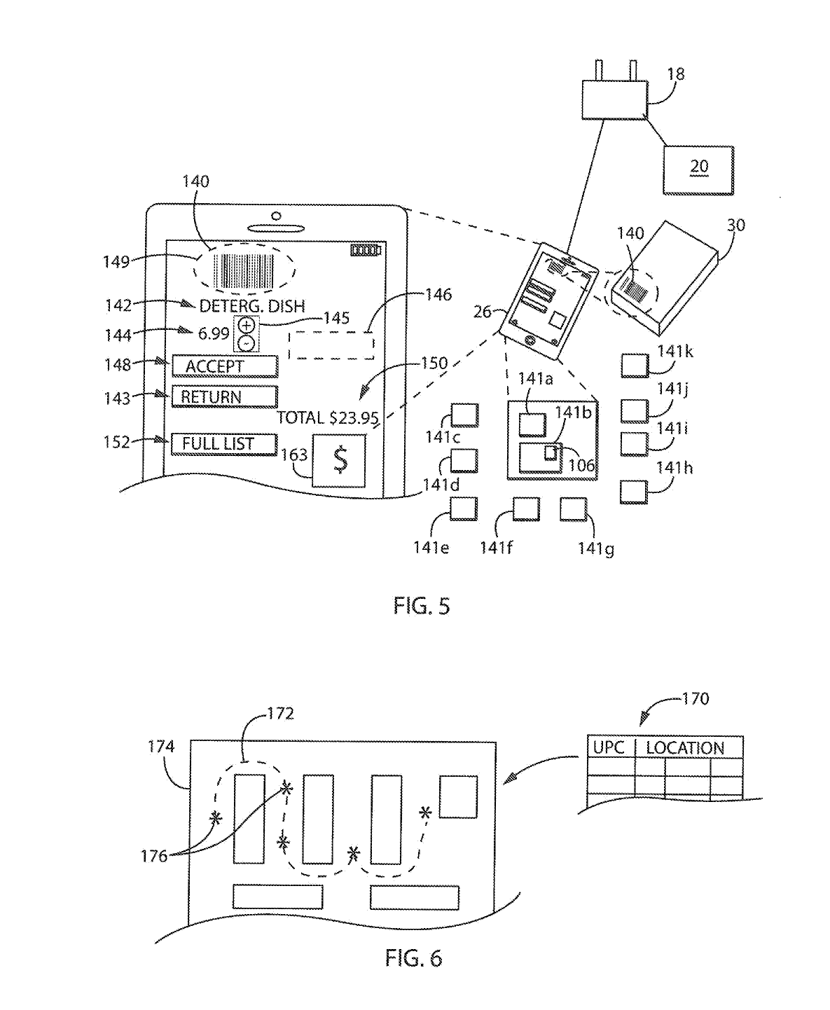

Referring now to FIG. 5, the process of roaming checkout which precedes this checkout process may be may be accomplished as the consumer 28 moves through the store selecting items for purchase using his or her mobile wireless device 26.

The mobile wireless device 26 may be any of a variety of portable consumer products or their equivalents including cell phones, tablets, or the like in the following description and also applies to the tablet 40 used by the store employee 39. Such devices typically include a processor 141a communicating with the memory 141b that may hold a self-checkout program and shopping cart data list 106 described above. As is generally understood in the art, such devices may further include a number of other hardware features including an accelerometer 141c, a compass 141d, a Wi-Fi transceiver 141e, a cell phone transceiver 141i, a graphic display 141g, a Bluetooth transceiver 141h, a touchpad 141i, a camera 141j and a speaker/microphone combination 141k.

Using the mobile wireless device 26, the consumer 28 moves through the store using the camera on the mobile wireless device 26 to scan a UPC code 140 on products 30 removed from the shelf for purchase. Once the UPC code is captured, communication between the mobile wireless device 26 and the interface server 20, for example, via the wireless network 18 or other communication channel described above, is used to present to the user additional detailed information about the product 142. This additional information may include a generic and brand name of the product 142, the product price 144 (optionally including a unit pricing), nutritional information 146, etc. In addition, the UPC barcode may be displayed to confirm clarity as image 149. This information is held in a temporary storage register. The quantity purchased may be indicated in an editing block 145 providing buttons to increase or decrease that quantity without multiple scanning. This editing capability mitigates any delay in the scanning process caused by the communication channel to the interface server 20.

If the consumer 28 elects to purchase the scanned product, the consumer 28 may press an accept button 148 preserving this information in shopping cart data list 106. Other information, for example, the net weight of the product stored in shopping cart data list 106, may or may not be displayed.

After being accepted by pressing the accept button 148, that product and all products that have been accepted may be reviewed at any time by a separate screen access by a full list button 152 providing a total shopping checkout list, if an accepted product is no longer desired, the return button 143 may be pressed removing it from the shopping cart data list 106. A total cost of the purchased products 150 may be displayed to the consumer 28. Information about the occurrence of a pressing of the accept button 148 or the return button 143 may be transmitted to the interface server 20, for example, to provide information about the consumer's reaction to promotional material delivered contemporaneously with scanning events as will be discussed below.

### Point of Decision Promotion

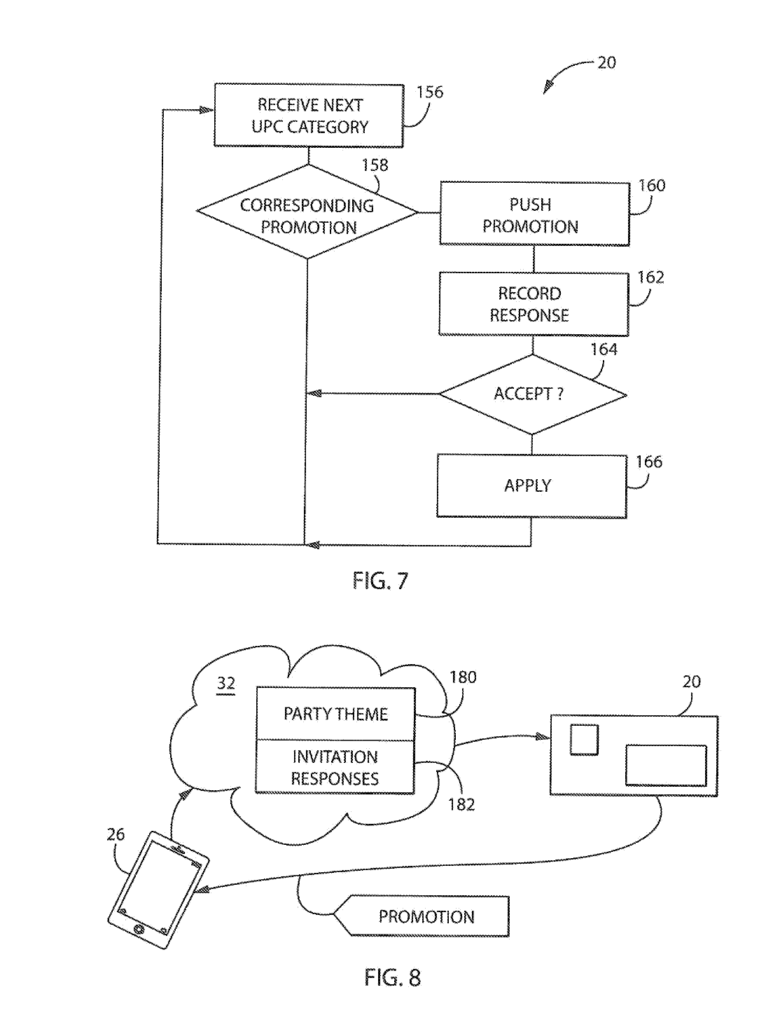

Referring now to FIGS. 5 and 7, the interface server 20 may execute a program in tandem with the self-checkout process of FIG. 4 where at process block 156 the interface server 20 receives the next UPC category of a product being reviewed by the consumer 28 (that is scanned) and not yet accepted. A UPC category describes the generic, product without a specific brand and may be derived from a reference table held at the interface server 20.

At decision block 158, the interface server 20 may review corresponding promotions for other products in or related to this UPC category to determine if there are any ongoing promotions for the product currently under review or competing or complementary brands. If so, at process block 160, the promotional information is pushed to the mobile wireless device 26 where it appears as a coupon icon 163. Subsequent response by the consumer 28 is observed and recorded at process block 162, for example, if the consumer 28 purchases the product for which the coupon is being offered and whether the promotion changes the consumer's purchasing decision by having them return a competing and un-promoted product. If the conditions for the promotion are accepted, as indicated by process block 164, for example, by the consumer 28 purchasing a qualifying product, the promotion is applied, at process block 166, indicating, for example, a deduction in the total cost of the product. A revised total cost of the purchased groceries may be adjusted and the coupon recorded in shopping cart data list 106 for processing at the time of checkout.

Another feature of the mobile application includes a bakery/deli/grocery ordering service. The consumer 28 can order, for example, cakes, deli sandwiches (i.e. for lunch), or their groceries through the application on their smartphone. The customer can specify exactly what they want, with the option to specify a time to pick-up or the grocery will specify the time. The order is then sent to the store, to a tablet or other receiver operated by a store employee and the order is then filled by the grocery store. The order will normally be tagged with a UPC code to allow self-checkout.

Referring now to FIG. 6, the stream of UPC information going to the interface server 20 may be used together with a store product map 170, the latter linking UPC codes to locations within the store, to plot a trajectory 172 of the consumer 28 through the store floor plan 174. This trajectory 172 may be determined without or augmented by other geolocation systems. Each UPC scan performed by the consumer 28, indicated by stars 176, may be connected by trajectory segments determined by dead reckoning using the compass and accelerometer of the smart phone to provide important marketing information about how consumers 28 move through the store.

Referring now to FIG. 8, the present invention, by providing compatibility with multiple POS systems 14, not only allows the consumer additional choice in shopping while using the benefits of the roaming checkout process, but provides manufacturers and the consumer with a more complete overview of all purchases by consumers 28 regardless of the store in which groceries are purchased. This allows for longitudinal tracking of buying habits, for example, determining after a promotion such as a coupon whether there is a lasting change in consumer behavior even for purchases among different stores. It also provides the consumer with a comprehensive record of purchases as will be described below.

The roving purchasing system may be used with a shopping list stored on the consumer's mobile wireless device 26 which will remind them of purchases and help guide them through the store to find the particular items that they need making use of the store product map 170. As items are scanned, they may be removed from the shopping list and from any shared shopping lists, for example, in systems that allow multiple individuals to divide up shopping responsibilities.

Freshness date information and tracking of consumer purchases may be used to help nominate materials to be added to the shopping list and may track previous purchases, for example, in a refrigerator or the like. The scanning feature of UPC codes may be used to scan empty containers of previously purchased products to rapidly populate a shopping list.

Another feature of the mobile application will be the ability, through tracking expiring items in the grocery store such as produce or meats, to offer heavily discounted coupons to users for those items that are close to expiring.

With the consumer's permission, the interface server 20 may receive information from a Facebook page or other web site allowing for entry of consumer preferences and plans. For example, the interface server 20 may receive information from such a site describing a consumer party theme 180 of a party that the consumer 28 plans, responses to invitations 182 sent by the consumer 28, for example, within the framework of the Facebook site to other friends, and their responses. This information may be used to match the party theme and party to promotions by particular manufacturers who make products that would be purchased for such a party and these promotions may be pushed to the mobile wireless device 26 to provide coupons for these purchased products. This feature may be implemented by allowing both product category and product use information to be matched in process block 158 described above against a promotion database managed by the interface server 20.

More generally, purchase information collected through the present invention (for example, purchase history, action history, movements in store, comments made, other user interaction, etc.) can be augmented with information pulled from a variety of other sources. This other information could show customer interests, events they are attending, friends they have and more. This information would be pulled in from sources like Facebook as described above (including Facebook “likes”, events being held, comments made, friend list, family list, etc.) but also from other social sites or collected marketing information. This augmentation of purchase information with other consumer information results in more relevant promotions to the consumer.

The present invention further contemplates that it will be able to provide content (concert tickets, movie previews, pictures and other media content) to users based on their social information. If a user “likes” a certain band, they may be offered the ability to redeem points for a ticket to their show. In addition, the invention may provide the ability to collect user friend/family lists and enable users to review products in the store. These reviews will be stored and also be visible to other users when they are purchasing new items. Thus the promotions need not be discount coupons for purchased items in the store.

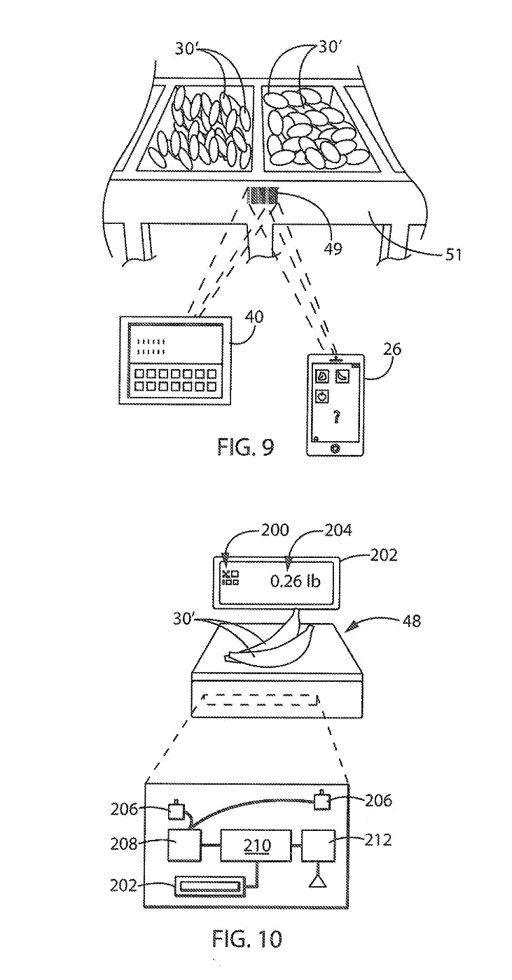

Referring now to FIG. 9, loose product 30 such as produce on a table 51 may not include UPC codes or may have missing or damaged UPC code information. This problem is addressed in one embodiment of the present invention by placing an area-relevant UPC code 49 on the table 51 (or stand associated with the table 51) that may be scanned by the mobile wireless device 26 used by the consumer 28 when purchasing such items. The area-relevant UPC code 49 may be affiliated with multiple different types of product 30 in the vicinity of the area-relevant UPC code 49. This affiliation is implemented by a store employee 39 using mobile device 40 to scan the area-relevant UPC code 49 mid to enter one or more product identifiers (e.g. SKU numbers) to be associated with the area-relevant UPC code 49 related to the product of the table 51. When multiple different products 30′ are associated with a single area-relevant UPC code 49, the mobile wireless device 26 after scanning the area-relevant UPC code 49 will show images of the multiple products 30′ and identification information and the consumer may simply select among them, for example, by touching the screen. Because relatively few products will be associated with any given single area-relevant UPC code 49, this additional selection process is simple and does not involve extensive indexing or review by the consumer. The linkage between the area-relevant UPC code 49 and the given products 30′ is transmitted to the interface server 20 which may then substitute appropriate UPC codes or other product identifiers as needed into the shopping cart data list 106.

In some cases, loose product 30′ such as produce will also need to be weighed. Referring now to FIG. 10, for this purpose the scale 48 may provide for wireless communication with the interface server 20 to relay weight information to the interface server 20 to be identified to a given product by the consumer 28. This identification may be performed by the consumer 28 manually identifying the scale 48 and the particular product being weighed, for example, as selected from products previously associated with area-relevant UPC codes 49 and flagged as requiring a weight. Typically there will only be one product or a limited number of products that the consumer needs to select among at any given time.

Alternatively, the weight and/or the scale identification may be encoded in a machine-generated, machine-readable code 200, for example, a QR code or bar code, that may be displayed on a graphic display 202 also used for the display of a human readable weight value 204. The consumer 28 may scan this machine-readable code 200 and then, as before, link it to a particular product requiring a weight that had been previously scanned (typically associated with an area-relevant UPC code 49). This machine-readable code 200 and the identified product are then transmitted to the interface server 20, for example, which translates this information into the data required for the shopping cart data list 106, for example, enrolling in the shopping cart data list 106 a random weight UPC code. This graphical communication pathway provided by the machine-readable code 200 eliminates the need for wireless or wired connections between the scale 48 and the interface server 20 allowing instead a mobile wireless device 26 to serve this purpose.

Internally the scale 48 may provide for electronic weight sensors 206 such as load cells or the like communicating with scale circuitry 208 which determines an accurate weight of product placed on the scale platform. Scale circuitry 208 may communicate the weight to a microcontroller 210 that may communicate with the display to output the machine-readable code 200 and the human-readable weight value 204. Alternatively or in addition, the microcontroller 210 may communicate with a network or wireless interface 212 to communicate this data to the interface server 20. The machine-readable code 200 may also include a unique scale authentication number, for example, providing a hash of the current date or the like to prevent scale spoofing.

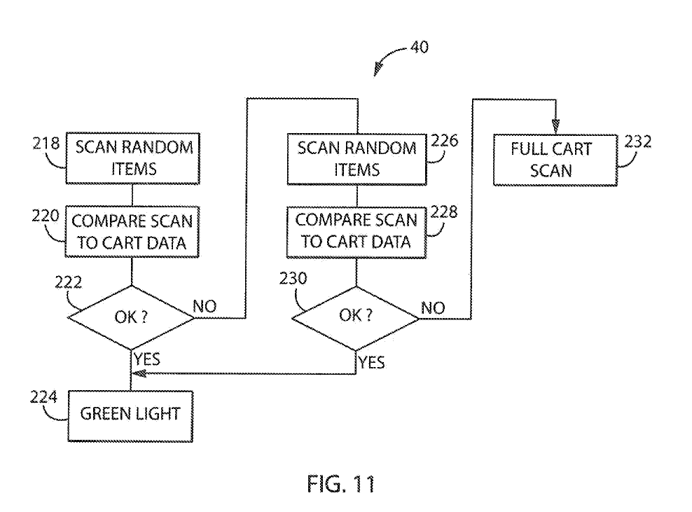

Referring now to FIGS. 1 and 11, in lieu of, or in addition to use of the weigh mat 36, the employee 39 may randomly select two products 30 (or some limited number) from the cart 38 for scanning by the tablet 40 at the time of checkout by the consumer 28. The selection process may be according to instructions received by the employee 39 over the tablet 40 as is represented by process block 218 of a program implemented, for example, by the interface server 20 communicating wirelessly with the tablet 40.

At process block 220, the program compares these two scanned items to the items in the downloaded shopping cart data list 106. If there is a match, then at decision block 222, a green symbol or other indication of acceptance is displayed to the employee 39 as indicated by process block 224 and the consumer check is completed.

If there is a mismatch, that mismatch may be corrected, for example, by the manual input of the missing items or other adjustment. The employee 39 is then instructed to scan two additional items as indicated by process block 226, for example, by instructions received through the tablet 40. Again there is a comparison of the scanned data of these new different items to the uploaded shopping cart data list 106 (on which payment was previously accepted and received) as indicated by process block 228. A comparison block 230 checks if the newly scanned items were properly checked out and if so the program proceeds to process block 224. If not, at process block 232, the employee 39 is instructed to perform a full audit of the cart 38, for example, using a regular checkout technique wherein each item is scanned in a conventional manner using the scanner 78. Consumers 28 associated with a history of erroneous shopping cart data list 106 may be flagged in subsequent returns or prohibited from use of the system. Yet in this way, the vast majority of consumers with properly checked out groceries have very little inconvenience.

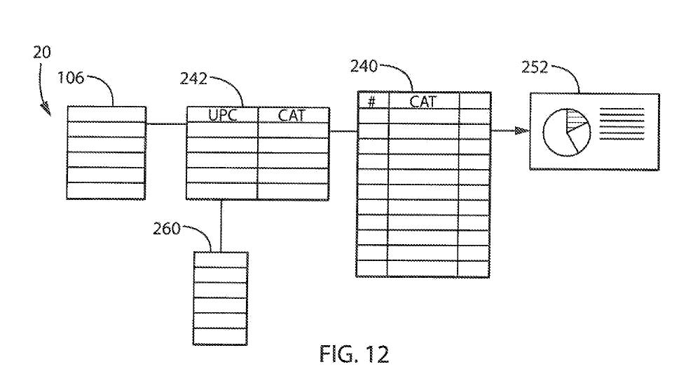

Referring now to FIG. 12, the ability of the present invention to work with a variety of different POS systems allows the consumer 28 to practically track all purchases even if they occur among, for example, multiple grocery stores. In this regard, the interface server 20 may implement a database collecting each shopping cart data list 106 into a master shopping history 240 combining the data of the shopping cart data lists 106 of multiple transactions over time together with date, category and store information. A translation table 242 may translate specific product identification information (for example, UPC code) into general categories of purchases (e.g. milk, chicken, frozen vegetables, etc.) so that the master shopping history 240 may provide useful category information to the consumer indicating where their purchasing dollars are spent. Referring momentarily also to FIG. 14, this aggregation process is shown by process block 244.

The master shopping history 240 may be held in a database accessible to the consumer, for example, on the Internet. Here, the interface server 20 may accept search query information as indicated by process block 246 from the consumer 28 related to his or her master shopping history 240. For example, the consumer 28 may provide a date range and a category query to receive a limited category sort 250 that may be displayed on a consumer-accessible webpage 252 indicating how many of the consumer's dollars went to particular categories of items, for example, food or nonfood items. The category information provided by the translation table 242 may alternatively allow the consumer, for example, to submit a nutritional query providing a nutritional information sort 254 indicating how much of the consumer's purchasing went into different nutritional categories, such as fresh produce or meat and poultry. Such a sort may be useful for those for monitoring their diet.

By having date information and category information for purchases over a period of time, the interface server 20 may create a virtual shopping list 256 by analyzing the timing and type of purchases of the consumer 28 to identify regular purchasing patterns. For example, by identifying milk purchases and establishing an average time between milk purchases, such as five days, milk may be added to the virtual shopping list 256 five days after its last purchase. This virtual shopping list 256 may be used as is or edited by the consumer to be available to the consumer during shopping as an actual shopping list 260.

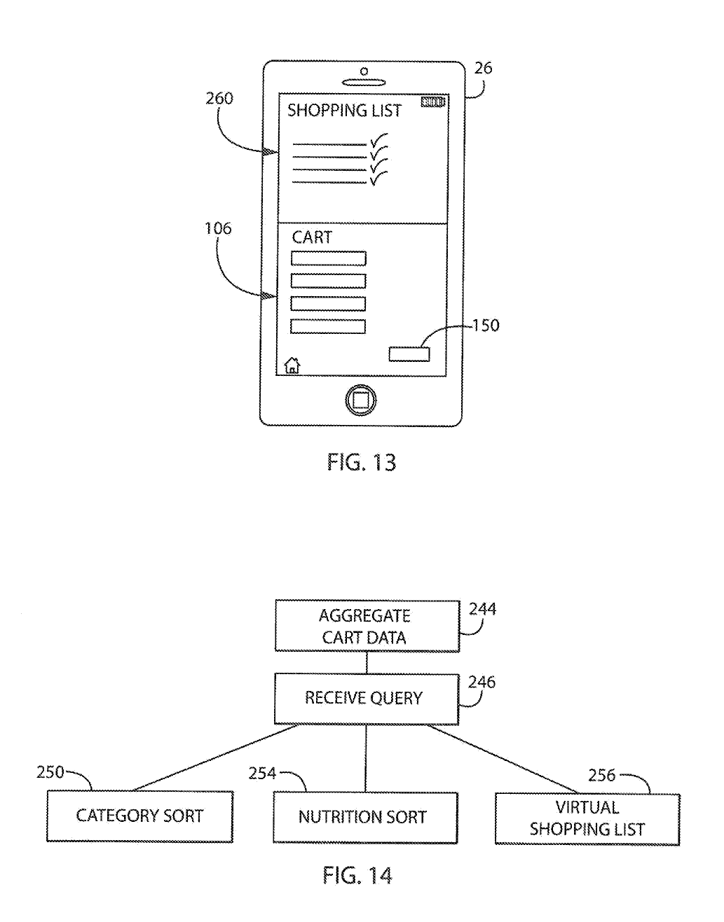

Referring to FIG. 13, the actual shopping list 260 or virtual shopping list 256 may be displayed on the mobile wireless device 26 during the purchasing process as category items (spaghetti sauce) or as particular brands based on the previous purchases by the consumer. As a consumer purchases items, the categories of these purchased items, deduced by the translation table 242, may be used to remove items from the shopping list 260 for the convenience of the consumer 28.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When computer systems are described, it is understood that they may be implemented by a single computer or multiple computers working in tandem and communicating, for example, remotely, to the Internet or the like. Thus for example, the interface server 20 and the interface device 16 together implement an interface computer system, although this function can be embodied in a single computer as well. Prefix terms such as user-computer, scale-computer, and interface-computer used herein and in the claims are intended simply to distinguish among multiple computers and not to otherwise limit these computers

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. A checkout system comprising:
an interface adapter attachable to a point-of-sale system between a point-of-sale computer and a peripheral device, the peripheral device inputting information about a purchase of products by a consumer for recording by the point-of-sale computer; and
an interface electronic computer system communicating with the interface adapter and a receiver communicating with a mobile wireless device and executing a program stored in non-transient medium to:
(a) receive a list of products for purchase by a consumer from a mobile wireless device operated by the consumer;
(b) convert the product list into a data form used by the peripheral device to communicate with the point-of-sale computer to provide a simulated peripheral datastream; and
(c) transmit the simulated peripheral datastream to the interface adapter to be communicated to the point-of-sale system in a manner of data normally received by the peripheral device to simulate inputting of information about the purchase of products by the consumer through the peripheral device.

2. The checkout system of claim 1 wherein the peripheral device is a barcode scanner and the data form is that of scanned UPC codes.

3. The checkout system of claim 1 wherein the interface adapter includes a switch controllable by the interface electronic computer system and wherein the interface electronic computer system actuates the switch during step (c) to provide a connection between the interface electronic computer system and the point-of-sale electronic system and upon completion of step (c) actuates the switch to break the connection between the interface electronic computer system and the point-of-sale system and make a connection between the peripheral and the point-of-sale system.

4. The checkout system of claim 1 wherein the receiver is a cell phone system receiver receiving cell phone encoded data from the mobile device.

5. The checkout system of claim 1 further including a mobile wireless device providing a camera, user-display, and a user data entry device and incorporating a user electronic computer communicating with the camera and executing a program stored in non-transient media to:
(i) scan product tags identifying a product to provide a product identifier;
(ii) display information about a product related to the product identifiers on the user-display for editing by the user through commands entered through the user data entry device;
(iii) store edited product identifiers in a virtual shopping cart; and
(iv) transmit data of the virtual shopping cart to an interface electronic computer system to provide the list of products for purchase by a consumer.

6. The checkout system of claim 5 further including the step of transmitting product identifiers by the user electronic computer contemporaneously with step (i) to the interface electronic computer system and wherein the interface electronic computer system further provides a database of promotions identified to particular products and wherein the interface electronic computer system further executes the step of:
(d) transmitting a promotion to the mobile wireless device based on a received product identifier.

7. The checkout system of claim 6 wherein the interface electronic computer system further executes the stored program to receive data over a network connection from a consumer indicating consumer preferences and wherein at step (i) the interface electronic computer system receives an identification of the consumer allowing matching of the consumer preferences to the list of products and wherein the promotion at step (iv) is further based on the consumer preferences.

8. The checkout system of claim 7 wherein the consumer preferences indicate an intended social event involving the purchase of products.

9. The checkout system of claim 5 wherein step (ii) includes an editing by the user deleting a product identifier after scanning of step (i) and further including the step of:
(v) transmitting to the interface electronic computer system a list of products scanned but not purchased by the consumer based on a recorded deleting of a product identifier after scanning.

10. The checkout system of claim 5 further including the step of transmitting product identifiers contemporaneously with step (i) to the interface electronic computer system and wherein the interface electronic computer system further provides a database of promotions identified to particular products and wherein the interface electronic computer system further executes the step of:
(d) transmitting a promotion to the mobile wireless device based on the product identifier and recording a deleting by the user of a product occurring after a promotion is transmitted to the user.

11. The checkout system of claim 1 wherein the interface adapter includes a first and second releasable electrical connector wherein the first electrical connector is adapted to be received by a corresponding electrical connector on the point-of-sale system and the second electrical connector is adapted to receive a corresponding connector on the peripheral.

12. The checkout system of claim 1 wherein the point-of-sale system provides a record of purchases by multiple different consumers.

13. The checkout system of claim 1 wherein the interface electronic computer system includes at least two electronic computers communicating over a network.

14. The checkout system of claim 1 wherein the interface electronic computer system further provides promotions based on the received list of products for purchase.

15. A method of checking out purchases made by a consumer using a system including:
an interface adapter attachable to a point-of-sale system between a point-of-sale computer and a peripheral device, the peripheral device inputting information about the purchase of products by a consumer for recording by the point-of-sale computer;
an interface electronic computer system communicating with the interface adapter and a receiver communicating with a mobile wireless device and executing a program stoned in Don-transient medium to:
(a) receive a list of products for purchase by a consumer from a mobile wireless device operated by the consumer;
(b) convert the product list into a data form used by the peripheral device to communicate with the point-of-sale computer to provide to simulated peripheral datastream; and
(c) transmit the simulated peripheral datastream to the interface adapter to be communicated to the point-of-sale system in a manner of data normally received by the peripheral device to simulate inputting of information about the purchase of products by the consumer through the peripheral device; the method comprising the steps of
(i) receiving a list of multiple products for purchase by a consumer from a mobile wireless device operated by the consumer;
(ii) converting the product list into a data form used by the peripheral device to communicate with the point-of-sale computer to provide a simulated peripheral datastream; and
(iii) transmitting the simulated peripheral datastream to the interface adapter to be communicated to the point-of-sale system in the manner of data normally received by the peripheral device to simulate inputting of information about the purchase of products by the consumer through the peripheral device.

16. An electronic scale system comprising:
a platform providing an upwardly facing surface for receiving items to be weighed;
a weight sensor communicating with the platform to provide an electronic signal indicating a weight of an item on the platform;
an electronic display viewable by a user of the platform;
an electronic computer communicating with the weight sensor and the display and executing a program stored in non-transient media to:
(a) receive the electronic signal indicating a weight of an item on the platform; and
(b) display on the display a machine-readable element encoding a weight value together with a human-readable element encoding the weight value.

17. The electronic scale system of claim 16 wherein the machine-readable element further encodes a scale identifier number uniquely identifying the electronic scale.

18. The electronic scale system of claim 16 further including a mobile wireless device providing a camera, a user-display, and a user data entry device and incorporating a user electronic computer communicating with the camera and display executing a program stored in non-transient media to:
(a) scan product tags identifying a product to provide a product identifier;
(b) scan the machine-readable element encoding a weight value;
(c) display on the user-display information about a product related to the product identifiers and the weight value;
(d) store edited product identifiers and weight value in a virtual shopping cart; and
(e) transmit data of the virtual shopping cart to an interface electronic computer system to provide a list of products for purchase by a consumer.

19. A checkout system comprising:
a product-merchandising stand holding product and a machine-readable scan code located on the stand separate from product held by the stand;
an interface electronic computer system communicating with a wireless transceiver and holding a data structure linking product identifiers to machine-readable scan codes; and
a mobile wireless device providing a camera, a user-display, and a user data entry device and incorporating a user electronic computer communicating with the camera and display executing a program stored in non-transient media to:
(a) scan the machine-readable scan code;
(b) display information about one or more products proximate to the machine-readable scan code for selection by the user through commands entered through the user-data entry device;
(c) store a product identifier related to the selected display products in a virtual shopping cart; and
(d) transmit data of the virtual shopping cart to the interface electronic computer system to provide a list of products for purchase by a consumer.
